(19) United States
(12) Patent Application Publication
(10) Pub. No.: US 2017/0089528 A1
(43) Pub. Date: Mar. 30, 2017

(54) LIGHT STRING

(71) Applicant: Guangzhou Kingyi Metal Product Co., Ltd., Guangzhou City (CN)

(72) Inventor: Yaowen HE, Ganzhou City (CN)

(21) Appl. No.: 14/887,022

(22) Filed: Oct. 19, 2015

(30) Foreign Application Priority Data
Sep. 29, 2015 (CN) 201510641228.3

(51) Int. Cl. F21S 4/20; F21V 3/04; F21V 23/00

(52) U.S. Cl. CPC F21S 4/20; F21V 23/002; F21V 3/0436; F21Y 2103/003

(57) ABSTRACT

The present invention relates to the field of semiconductor light emitting technology, and particularly to a light string, which comprises a conducting wire, a transparent protective cover and a plurality of light emitting components, wherein the plurality of light emitting components are all electrically connected to the conducting wire; and the transparent protective cover is provided outside of the conducting wire and the plurality of light emitting components. In the light string provided by the present invention, the transparent protective cover is provided outside of the conducting wire, so as to avoid the enameled wire from having the coating falling off due to external friction, therefore prolonging the use life of the light string.

### CROSS-REFERENCE TO RELATED APPLICATION

The present application claims priority to Chinese patent application 201510641228.3 filed Sep. 29, 2015, which is incorporated herein by reference in its entirety.

### TECHNICAL FIELD

The present invention relates to the field of semiconductor light emitting technology, and particularly to a string of lights, called a light string.

### BACKGROUND ART

LED is an abbreviation for a light emitting diode, and the basic structure of which is an electroluminescent chip made of semiconductor material. The chip is glued and fixed to a bracket with silver glue or white glue being cured, and is connected to a circuit board with silver wires or gold wires, and then periphery of the chip is sealed with epoxy resin to protect the inner chip and wires, and finally a housing is installed, thus the LED light having good anti-vibration performance. The core of a LED is a semiconductor chip, one side of which is attached to the bracket. One end of the chip is a negative electrode, and the other end thereof is connected to a positive electrode of a power supply. The whole chip is encapsulated by epoxy resin. LEDs may be applied in the fields relating to daily products, such as mobile phones, table lamps and household electrical appliances, and machinery production.

The so-called LED lamp bead refers to a light emitting diode, with the LED as the abbreviation. A LED light string refers to such a product, in which a plurality of LED lamp beads are mounted onto a belt for lights, including a conducting wire and the plurality of lamp beads mounted in series on the conducting wire. In daily life, a LED light string is commonly used in decoration.

The LED light string in the prior art has a conducting wire in the form of enameled wire, whose coating easily falls off due to friction after a long-term use, causing short circuit, and the service life shorten.

### DISCLOSURE OF THE PRESENT INVENTION

An object of the present invention is to provide a light string to solve the technical problems in the prior art that the enameled wire of the light string has the coating easily falling off.

The light string provided by the present invention comprises a conducting wire, a transparent protective cover and a plurality of light emitting components, wherein the plurality of light emitting components are electrically connected to the conducting wire; and the transparent protective cover is provided outside of the conducting wire and the plurality of light emitting components.

Further, the light string comprises a mouldable fixed shaft, the transparent protective cover is in a shape of elongated strip, and the mouldable fixed shaft penetrates inside the transparent protective cover.

Further, the transparent protective cover is provided therein with toner.

Further, one end of the light string is provided with a plug, one end of the transparent protective cover is inserted in the plug, and the conducting wire is electrically connected to the plug.

Further, the light string comprises an encapsulated head, which is a hollow case opening at one end, and one end of the transparent protective cover away from the plug is inserted in the encapsulated head.

Further, the plug comprises a plug body, and the outer surface of the plug body is provided with a plurality of friction projections.

Further, the transparent protective cover is made of polyethylene.

Further, the cross-section of the transparent protective cover is semicircular.

Further, the conducting wire comprises a first sub-line and a second sub-line, which are arranged in parallel, a positive electrode of each light emitting component is connected to a positive electrode of a power supply through the first sub-line, and a negative electrode of each light emitting component is connected to a negative electrode of the power supply through the second sub-line.

Further, a transparent packaging layer is externally provided on the light emitting components and the junction between the light emitting components and the conducting wire.

In the light string provided by the present invention, the transparent protective cover is provided outside of the conducting wire, with the transparent protective cover capable of avoiding the enameled wire from having the coating falling off due to external friction, which prolongs the use life of the light string.

### BRIEF DESCRIPTION OF DRAWINGS

In order to more clearly illustrate specific embodiments of the present invention or technical solutions of the prior art, accompanying drawings used in description of the specific embodiments or the prior art will be described simply below. Obviously, the accompanying drawings in the following description are used for some embodiments of the present invention, and other drawings can be obtained based on these drawings for those ordinary skilled in the art without creative efforts.

FIG. 1 is a structural schematic view of a light string provided by an embodiment of the present invention; and

FIG. 2 is a structural schematic view of a light string provided by another embodiment of the present invention.

### REFERENCE SIGNS

1—conducting wire; 2—light emitting component;
3—transparent protective cover; 4—mouldable fixed shaft; 5—plug;
6—encapsulated head; 11—first sub-line; 12—second sub-line.

### DETAILED DESCRIPTION OF EMBODIMENTS

Below, the technical solutions of the present invention will be described clearly and completely, in conjunction with the accompanying drawings. Obviously, the described embodiments are part of the embodiments of the present invention, rather than all embodiments. Based on the embodiments of the present invention, all other embodiments obtained by those ordinary skilled in the art without creative efforts are within the protection scope of the present invention.

It should be noted that, in the description of the present invention, orientation or position relationship indicated by terms such as “center”, “upper”, “lower”, “left”, “right”, “vertical”, “horizontal”, “inside” and “outside” is based on the orientation or positional relationship shown in the drawings, only to facilitate and simplify the description of the present invention, but not to indicate or imply that a device or element referred to must be in the specific orientation or be constructed and operate in the specific orientation, and therefore cannot be construed as a limitation to the present invention. In addition, terms such as “first”, “second” and “third” are used only for purpose of description and not construed as indication or implication of relative importance.

It should be noted that, in the description of the present invention, terms such as “installation”, “connected” and “connection” should be broadly understood, unless otherwise expressed and limited specifically. For example, it may be a fixed connection, or a removable connection, or connected integrally; it may be a mechanical connection or electrical connection; it may be a direct connection, or indirect connection through an intermediary, or may be an internal communication between two components. For those skilled in the art, the particular meaning of the above terms in the present invention can be understood depending on specific circumstances.

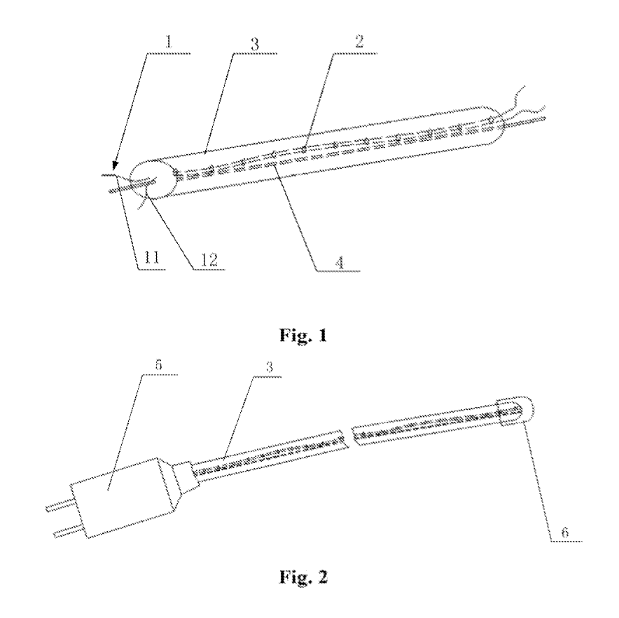

FIG. 1 is a structural schematic view of a light string provided by an embodiment of the present invention. As shown in FIG. 1, the light string provided by this embodiment comprises a conducting wire 1, a transparent protective cover 3 and a plurality of light emitting components 2, wherein the plurality of light emitting components 2 are all electrically connected to the conducting wire 1; and the transparent protective cover 3 is provided outside of the conducting wire 1 and the plurality of light emitting components 2.

Herein, the transparent protective cover 3 may be solid or hollow. When the transparent protective cover 3 is solid, it can wrap the conducting wire 1 and the plurality of light emitting components 2 more tightly, making the conducting wire 1 and the plurality of light emitting components 2 fixed in the transparent protective cover 3, thus avoiding the damage due to friction between the conducting wire 1, the plurality of light emitting components 2 and the transparent protective cover 3, and prolonging use life of the light string. Further, when the transparent protective cover 3 is solid, the light emitting component 2 emits light after being powered, and the light from the light emitting component 2 is refracted in the transparent protective cover 3, achieving sense of reality like a crystal, and improving the overall use effect of the light string.

The transparent protective cover 3 may be transparent partially or completely. When the transparent protective cover 3 is partially transparent, the portions of the transparent protective cover 3 covering lamp beads are configured as being transparent, and the portions of the transparent protective cover 3 covering the conducting wire 1 are configured as being opaque. When the transparent protective cover 3 is completely transparent, the light string is glittering and translucent after the light emitting components 2 being powered.

Material of the transparent protective cover 3 may be transparent plastic, such as PVC, polycarbonate or polystyrene and so on. When the transparent protective cover 3 is transparent plastic, the insulation performance of the light string may be increased and the safety of the light string in use may be improved, because the transparent plastic is insulating material. In addition, since the transparent protective cover 3 is configured as being made of transparent plastic so as to prevent water from entering the conducting wire 1 and the light emitting components 2, the waterproof performance of the light string is improved, therefore the light string can be placed and used in water, the use range of the light string is expanded.

The light emitting components 2 may be LED light emitting components, and the conducting wire 1 may be a PVC wire, PE wire or electric wire.

In the light string provided by this embodiment, the transparent protective cover 3 is provided outside of the conducting wire 1, capable of avoiding the enameled wire from having the coating falling off due to external friction, and prolonging the use life of the light string.

As shown in FIG. 1, on the basis of the above embodiment, further, the light string also comprises a mouldable fixed shaft 4; the transparent protective cover 3 in a shape of an elongated strip; and the mouldable fixed shaft 4 penetrating inside the transparent protective cover 3.

Herein, the mouldable fixed shaft 4 may be made of a variety of materials, such as copper, iron or aluminum and so on.

the mouldable fixed shaft 4 may be provided at various positions, for example, the mouldable fixed shaft 4 is arranged in parallel with the conducting wire 1, making the conducting wire 1 and the mouldable fixed shaft 4 deformed consistently, thereby changing the shape of the conducting wire 1 more accurately. It is also possible that the mouldable fixed shaft 4 is wrapped around the conducting wire 1, which can further enhance the robustness of the conducting wire 1.

The transparent protective cover 3 may have a variety of Sectional shapes, such as circular, square or diamond-shaped and so on.

In this embodiment, the mouldable fixed shaft 4 is provided inside the transparent protective cover 3, the shapes of the conducting wire 1 and the transparent protective cover 3 can be changed by changing the shape of the mouldable fixed shaft 4, which in turn allows a user to layout different shapes of the light string according to the use occasion or his/her preference, improving the applicability of the light string.

As shown in FIG. 1, on the basis of the above embodiment, further, the transparent protective cover 3 is also provided therein with toner.

In this embodiment, that the toner is provided inside the transparent protective cover 3 can change color of the transparent protective cover 3. A user can provide toner with different color according to his/her preference, so that the light string emits different colors of light.

FIG. 2 is a structural schematic view of a light string provided by another embodiment of the present invention. As shown in FIG. 2, on the basis of the above embodiment, further, one end of the light string is provided with a plug 5. One end of the transparent protective cover 3 is inserted in the plug 5, and the conducting wire 1 is electrically connected to the plug 5.

In this embodiment, the transparent protective cover 3 is connected with the plug 5, and the transparent protective cover 3 is inserted in the plug 5, enhancing insulation at the junction between the conducting wire 1 and the plug 5, and improving safety of the plug 5 in use.

As shown in FIG. 2, on the basis of the above embodiment, further, the light string comprises an encapsulated head 6. The encapsulated head 6 is a hollow case with one end opening, and one end of the transparent protective cover 3 away from the plug 5 is inserted in the encapsulated head 6.

Herein, the encapsulated head 6 may have a variety of sectional shapes, such as circular, square or diamond-shaped and so on. Preferably, the sectional shape of the encapsulated head 6 is consistent with that of the transparent protective cover 3, thus the encapsulated head 6 can wrap the transparent protective cover 3 more tightly, so that the transparent protective cover 3 is not easy to slide out from the encapsulated head 6.

The encapsulated head 6 and the transparent protective cover 3 may be in a fixed connection; for example, the encapsulated head 6 and the transparent protective cover 3 are connected together by adhesive.

It is also possible that the encapsulated head 6 and the transparent protective cover 3 is in a removable connection; for example, the encapsulated head 6 is connected with the transparent protective cover 3 through a resilient projection and a recess cooperating with the resilient projection, with the recess provided in an outer wall of the transparent protective cover 3, the resilient projection provided on an inner wall of the encapsulated head 6. And in use of the light string, the resilient projection is clapped in the recess. When the light string is required to be removed, pulling the resilient projection out from the recess is enough. The encapsulated head 6 and the transparent protective cover 3 are connected together through cooperation between the recess and the resilient projection, thus the encapsulated head 6 can be fixed in the encapsulated head 6 more firmly, moreover it is also facilitate to remove the transparent protective cover 3 from the encapsulated head 6, having the simple structure, and being easy to use.

The encapsulated head 6 may be made of a variety of materials, such as plastic, rubber or metal and so on.

In this embodiment, the encapsulated head 6 is provided at one end of the transparent protective cover 3, avoiding the end of the transparent protective cover 3 from being damaged due to external friction, and improving the use life of the transparent protective cover 3. In addition, the encapsulated head 6 has the simple structure and is easy to be manufactured.

As shown in FIG. 2, on the basis of the above embodiment, further, the plug 5 comprises a plug body, and a plurality of friction projections are provided on the outer surface of the plug body.

Herein, the friction projections may be in a variety of shape, such as rectangular, circular or irregular shape and so on.

In this embodiment, the plurality of friction projections are provided on the outer surface of the plug body. When a user inserts or pulls out the plug 5 by hand holding the plug body, friction between fingers and the plug body increases, avoiding the fingers from slipping off the plug body, facilitating the user to apply a force to the plug body, and being easy to use.

As shown in FIG. 1, on the basis of the above embodiment, further, the material of the transparent protective cover 3 is polyethylene.

In this embodiment, as the transparent protective cover 3 is configured as being made of polyethylene with the polyethylene having excellent low temperature resistance (the lowest working temperature may be up to −100˜−70° C.) and good chemical stability, the transparent protective cover has corrosion resistance to most acids and alkalis, the lower water absorption and the excellent electrical insulation. Accordingly, the transparent protective cover 3 made of polyethylene material has better insulation and waterproof performance, improving insulation and waterproof properties of the transparent protective cover 3.

As shown in FIG. 1, on the basis of the above embodiment, further, the cross-section of the transparent protective cover 3 is semicircular.

In this embodiment, the cross-section of the transparent protective cover 3 is configured as being semicircular. When the light string is required to be fixed on a wall, the flat side of the transparent protective cover 3 is tightly attached to surface of the wall. Because both the semicircular flat side and the surface of the wall are planes, the light string can be fixed tightly to the wall. The semicircular shape increases the contact area between the transparent protective cover 3 with the surface of the wall, and the transparent protective cover 3 can be fixed to the surface of the wall more securely.

As shown in FIG. 1, on the basis of the above embodiment, further, the conducting wire 1 comprises a first sub-line 11 and a second sub-line 12, which are arranged in parallel. A positive electrode of each light emitting component 2 is connected to a positive electrode of a power supply through the first sub-line 11, and a negative electrode of each light emitting component 2 is connected to a negative electrode of the power supply through the second sub-line 12.

Herein, the first sub-line 11 and the second sub-line 12 may be two separate conducting wires, or may be arranged in such a way that the two conductors are covered under the same insulating layer and spaced by an insulating material layer.

The light emitting components 2 and the first and second sub-lines 11, 12 may have a variety of connecting structures, for example, the first sub-line 11 and the second sub-line 12 each includes a conductor and an insulating layer wrapped outside of the conductor; the insulating layer of the first sub-line 11 is provided thereon with a plurality of first openings sequentially spaced apart along an extending direction of the first sub-line 11 such that the conductor at the first opening forms a first contact surface; the insulating layer of the second sub-line 12 are provided thereon with a plurality of second openings sequentially spaced apart along an extending direction of the second sub-line 11 such that to the conductor at the second opening forms a second contact surface; the positive electrodes of the light emitting components 2 are connected to the first contact surfaces, and the negative electrodes thereof are connected to the second contact surfaces.

In this embodiment, the first sub-line 11 and the second sub-line 12 are arranged in parallel, and the light emitting components 2 are connected to the power supply through the first sub-line 11 and the second sub-line 12, avoiding the problem of a traditional light string that a pair of conducting wires of each LED light are connected one by one to the same conductor, therefore decreasing difficulty of manufacturing the light string, improving manufacturing efficiency, and facilitating the mass production.

As shown in FIG. 1, on the basis of the above embodiment, further, a transparent packaging layer is provided outside of the light emitting components 2 and of the junction between the light emitting components 2 and the conducting wire 1.

In this embodiment, the transparent packaging layer provided outside of the light emitting components 2 and the junction between the light emitting components 2 and the conducting wire 1 wraps the junctions, avoiding dust or other impurities from entering to affect the electrical properties of the conductors, therefore improving the use life of the light string.

Finally, it should be noted that the above embodiments are merely provided for describing the technical solutions of the present invention, but not intended to limit it. Although the present invention has been described in detail referencing to the above mentioned embodiments, those skilled in the art will appreciate that the technical solutions of the above mentioned embodiments can still be modified, or part or all of the technical features can be equivalently replaced; and such modifications or replacements do not make the corresponding technical solutions essentially depart from the scope of the present invention.

1. A light string comprising a conducting wire, a transparent protective cover and a plurality of light emitting components, wherein the plurality of light emitting components are all electrically connected to the conducting wire; and the transparent protective cover is provided outside of the conducting wire and the plurality of light emitting components.

2. The light string according to claim 1, further comprising a mouldable fixed shaft, wherein the transparent protective cover is in a shape of an elongated strip, and the mouldable fixed shaft penetrates inside the transparent protective cover.

3. The light string according to claim 1, wherein toner is provided inside the transparent protective cover.

4. The light string according to claim 1, wherein one end of the light string is provided with a plug, one end of the transparent protective cover is inserted in the plug, and the conducting wire is electrically connected to the plug.

5. The light string according to claim 4, further comprising an encapsulated head, which is a hollow case with one end opening, wherein one end of the transparent protective cover away from the plug is inserted in the encapsulated head.

6. The light string according to claim 4, wherein the plug comprises a plug body, and a plurality of friction projections are provided on an outer surface of the plug body.

7. The light string according to claim 1, wherein the transparent protective cover is made of polyethylene material.

8. The light string according to claim 1, wherein the transparent protective cover has a semicircular cross-section.

9. The light string according to claim 1, wherein the conducting wire comprises a first sub-line and a second sub-line, which are arranged in parallel, a positive electrode of each light emitting component is connected to a positive electrode of a power supply through the first sub-line, and a negative electrode of each light emitting component is connected to a negative electrode of the power supply through the second sub-line.

10. The light string according to claim 9, wherein a transparent packaging layer is provided outside of the light emitting components and junctions between the light emitting components and the conducting wire.
